(19) United States
(12) Patent Application Publication
(10) Pub. No.: US 2016/0137774 A1
(43) Pub. Date: May 19, 2016

(54) LACTONE POLYMERIZATION WITH LATENT INITIATORS

(71) Applicant: EVONIK DEGUSSA GMBH, Essen (DE)

(72) Inventors: Friedrich Georg SCHMIDT, Haltern am See (DE); Michael BUCHMEISER, Remshalden (DE); Stefan NAUMANN, Heilbronn (DE)

(73) Assignee: EVONIK DEGUSSA GMBH, Essen (DE)

(21) Appl. No.: 14/777,987

(22) PCT Filed: Feb. 26, 2014
(86) PCT No.: PCT/EP2014/053697

§ 371 Date: Sep. 17, 2015

(30) Foreign Application Priority Data
Mar. 25, 2013 (DE) 10 2013 205 186.7

(51) Int. Cl. C08G 63/08; C07F 3/02; C07F 3/06

(52) U.S. Cl. CPC C08G 63/08; C07F 3/06; C07F 3/02

(57) ABSTRACT

The present invention relates to a novel, rapid initiating mechanism for anionic, ring-opening polymerization of lactones by means of latent initiators based on N-heterocyclic carbene compounds which can be thermally activated, such as, in particular, N-heterocyclic carbene-CO₂, carbene-CS₂ and carbene-metal compounds (NHC). Molecular weights of 2000 to more than 20 000 g/mol and narrow polydispersities can thus be realized using the novel initiating mechanism for the polymerization of ε-caprolactone. The polymerizations may be carried out either without solvent or in solution. Compounds of this type are thermally latent and initiate a polymerization to give polylactones on heating, sometimes in high yields up to a level of quantitative conversion, while a reaction does not occur at room temperature. The polydispersity and molecular weight of the polylactone can be adjusted by selection of the initiator and the reaction conditions.

### FIELD OF THE INVENTION

The present invention relates to a novel, rapid initiating mechanism for anionic, ring-opening polymerization of lactones by means of latent initiators based on N-heterocyclic carbene compounds which can be thermally activated, such as, in particular, N-heterocyclic carbene-CO₂, carbene-CS₂ and carbene-metal compounds (NHC). Molecular weights of 2000 to more than 20 000 g/mol and narrow polydispersities can thus be realized using the novel initiating mechanism for the polymerization of ε-caprolactone. The polymerizations may be carried out either without solvent or in solution. Compounds of this type are thermally latent and initiate a polymerization to give polylactones on heating, sometimes in high yields up to a level of quantitative conversion, while a reaction does not occur at room temperature. The polydispersity and molecular weight of the polylactone can be adjusted by selection of the initiator and the reaction conditions.

### PRIOR ART

The polymerization of lactones is generally accomplished by means of an anionic ring-opening polymerization. For this purpose, bases or Lewis bases are used as initiators. Thus, suitable examples are metal alkyls, amines, phosphines or alkoxides. Alkoxides are used in particular for the anionic ring-opening polymeristion (ROP) of lactones.

Alternatively, a cationic ring-opening polymerization is also suitable. This can be initiated with protic acids, Lewis acids or else alkylating agents. Overall, the cationic polymerization, however, tends to lead to side-reactions, such as transesterification or cyclization. For this reason, the molecular weight achievable is considerably reduced compared to an anionic ROP. There is additionally also the possibility of preparing lactones by means of enzyme catalysed ROP using lipases. However, this reaction takes place spontaneously and can only be stopped with difficulty after an addition of the initiator.

The metal-catalysed coordination-insertion polymerization, in contrast, is industrially important. For this purpose, tin, aluminium or titanium compounds are used in bulk.

However, all these methods have in common that the polymerization begins already at low temperatures, such as at room temperature. For this reason, lactones according to the prior art are only very poorly suited to particular applications, particularly for preparing composite materials for example. For this purpose, a temperature-dependent latency of the initiator or initiator system would be required.

N-Heterocyclic carbenes (NHC) have long been known as co-initiators to the silyl initiators in a Group Transfer Polymerization (GTP) (cf. Raynaud et al., Angew. Chem. Int. Ed., 2008, 47, p. 5390 and Scholten et al., Macromolecules, 2008, 41, p. 7399). N-Heterocyclic carbenes are also known as initiators in a Step-Growth Polymerization of terephthalaldehyde (cf. Pionaud et al., Macromolecules, 2009, 42, p. 4932). Zhang et al. (Angew. Chem. Int. Ed., 2010, 49, p. 10158) discloses NHC also as a Lewis base in combination with Lewis acids, such as NHC.Al(C₆F₅)₃ or NHC.BF₃. This combination is suitable as an initiator for MMA. Zhang et al. (Angew. Chem., 2012, 124, p. 2515) discloses 1,3-di-tert-butylimidazolin-2-ylidene, also alone, as initiator for the polymerization of MMA or furfuryl methacrylate. In this case, however, it was realized that other NHCs have no initiating effect on MMA but only on the cyclic monomers such as α-methylene-γ-butyrolactone (MBL) or γ-methyl-α-methylene-γ-butyrolactone (MMBL). In addition, the carbenes used here are themselves very reactive, such that firstly the handling is difficult and secondly the polymerization is rapidly initiated and in a manner which is relatively difficult to control.

Kamber et al. (Macromolecules 2009, 42, pp. 1634-1639) describe substituted imidazoles as N-heterocyclic carbenes (NHC) for initiating an ROP of ε-caprolactone. The polymerization takes place in this case with high activity even at room temperature. Nyce et al. (J. Am. Chem. Soc., 2003, 125, pp. 3046-3056) describe to this end the in situ formation of carbene from an imidazole halide using an alkoxide. Here also the polymerization takes place spontaneously at room temperature at a very high rate. Shion et al. (Macromolecules, 2011, 44, pp. 2773-2779) describe the same method using imidazole ylidenes. These zwitterions lead—also at room temperature—to polymers with considerably higher molecular weights.

### OBJECT

It was an object of the present invention, against the background of the prior art discussed, to make available novel latent initiators for polymerizing cyclic esters, particularly lactones. It shall be possible to initiate the polymerization in a controlled manner on the one hand and at the same time the polymerization should be rapid and simple to perform following the initiation.

Furthermore, it was an object of the present invention to make available a compound as latent initiator which is stable for at least 8 h in the presence of monomers at temperatures of up to 40° C., i.e. which leads to not more than 5% monomer conversion and which, at the same time, leads to at least 90% conversion of the monomers to polymers following activation.

Moreover, the compounds used as latent initiators shall, per se, be stable on storage and easy and safe to handle.

Furthermore, a mixture of the initiators and lactones shall be stable on storage such that a woven fabric or knitted fabric may be saturated with it without any problems and subsequently a composite material may be prepared from the saturated woven fabrics or knitted fabrics by activation of the polymerization.

Further objects not explicitly stated may arise from the description, the examples and also the claims, even without being explicitly mentioned at this point.

### SOLUTION

The objects are achieved by a novel method for initiating a polymerization of lactones. In this method, the monomer mixture or monomer solution is treated with a protected N-heterocyclic carbene and the polymerization is initiated by increasing the temperature to a starting temperature of at least 40° C., preferably at least 50° C. The polymerization is particularly preferably initiated at a temperature between 50° C. and 100° C. The initiators according to the invention are notable in particular in that these exhibit no, or barely any, activity at a relatively low temperature, particularly at room temperature, and therefore a mixture of the initiators and the lactones is stable on storage. “Barely any activity” in this context means that no more than 5% conversion of the monomers arises from a mixture of the lactones and the initiator over a period of 20 h at room temperature.

The wording monomer mixture here particularly also includes mixtures which contain only one type of lactone, such as ε-caprolactone.

In addition, an alcohol, particularly an alcohol with a very acidic hydrogen atom, is preferably also added to the N-heterocyclic carbenes. Particularly preferred alcohols are phenols or benzyl alcohols. If such alcohols are added, these are particularly preferably added to the N-heterocyclic carbenes in a quantitative ratio between 0.1 to 1 and 10 to 1.

Thus, such mixtures may be used particularly very well for the preparation of composites. In this instance, for example, fibrous supports in the form of pre-formed scrims or knitted fabrics for example, are saturated with the mixture and are subsequently heated to the initiation temperature. The exact initiation temperature depends on the respective initiator, i.e. on the carbene and the protective group used and is simple for those skilled in the art to determine for the individual case.

The fibrous supports may, for example, consist of glass, carbon, plastics such as polyamide (aramid) or polyester, natural fibres or mineral fibre materials such as basalt fibres or ceramic fibres. The fibres preferably form a textile surface formed from nonwovens, knitted goods, warp knits or circular knits, non-loop type formations such as fabrics, scrims or braidings. The fibres may, however, also be present simply as long-fibre or short-fibre materials.

This method is suitable for polymerizing lactones. Mixtures of various lactones may also be polymerized using the method according to the invention. The method according to the invention is particularly suitable for polymerizing γ-butyrolactone, δ-valerolactone and/or ε-caprolactone.

In particular, the protected N-heterocyclic carbene is a compound with one of the two formulae (I) or (II)

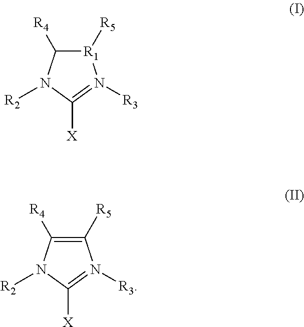

R₁ is a CH₂, C₂H₄, C₃H₆ or a corresponding substituted residue. R₂ and R₃ may be identical or different from one another. R₂ and R₃ are preferably cyclic, branched or linear, optionally heteroatom-containing alkyl residues having 1 to 20 carbon atoms or are substituted or unsubstituted aromatic residues. R₄ and R₅ may be identical or different from one another. R₄ and R₅ are preferably hydrogen, cyclic, branched or linear, optionally heteroatom-containing alkyl residues having 1 to 20 carbon atoms or are substituted or unsubstituted aromatic residues. X is CO₂, CS₂, Zn, Bi, Sn or Mg, where the metals listed represent different metal compounds. In particular, the metal protective groups are ZnX′₂, BiX′₃, SnX′₂ or MgX′₂, where X′ is a halogen or a pseudohalogen, preferably Cl. In addition, the metal protective groups may have further co-ordinated molecules, such as a solvent molecule such as, in particular, tetrahydrofuran (thf).

Carbenes having one of these X groups are stable on storage and simple as well as safe to use. Preferably these groups are carboxylates (CO₂ protective group) or dithionates (CS₂ protective group), since the polymerization can take place metal-free with these compounds.

Examples of the N-heterocyclic base structure of the initiators used according to the invention are particularly imidazole, imidazoline, tetrahydropyrimidine and diazepine.

Alternatively, the protected N-heterocyclic carbene is a compound with one of the two formulae (III) or (IV)

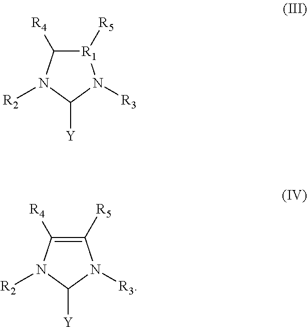

R₁ is again a CH₂, C₂H₄, C₃H₆ or a corresponding substituted residue. R₂ and R₃ may likewise again be identical or different from one another. In these cases also, they are preferably cyclic, branched or linear, optionally heteroatom-containing alkyl residues having 1 to 20 carbon atoms or they are substituted or unsubstituted aromatic residues. R₄ and R₅ may be identical or different from one another. R₄ and R₅ are preferably hydrogen, cyclic, branched or linear, optionally heteroatom-containing alkyl residues having 1 to 20 carbon atoms or are substituted or unsubstituted aromatic residues. The protective group Y, in contrast, may be a CF₃, C₆F₄, C₆F₅, CCl₃ or OR₆ residue, where R₆ is an alkyl residue having 1 to 10 carbon atoms. Analogously to compounds (I) and (II), the compounds (III) and (IV) may also be N-heterocyclic carbenes with a metal protective group based on Zn, Bi, Sn or Mg. Here also, the metals listed represent different metal compounds. In particular, the metal protective groups are ZnX′₂, BiX′₃, SnX′₂ or MgX′₂, where X′ is a halogen or a pseudohalogen, preferably Cl. In addition, the metal protective groups may have further co-ordinated molecules, such as a solvent molecule such as, in particular, tetrahydrofuran (thf).

Some CO₂-protected N-heterocyclic carbenes are presented below, although this list is not to be interpreted in any form in a restricted manner. The protective group may especially also be replaced by one of the other protective groups listed. Examples of N-heterocyclic carbenes of formula (I) having a six-membered ring—i.e. R₁ is a (CH₂)₂ group—are 1,3-dimethyltetrahydropyrimidinium-2-carboxylate (1), 1,3-diisopropyltetrahydropyrimidinium-2-carboxylate (2), 1,3-bis(2,4,6-trimethylphenyl)tetrahydropyrimidinium-2-carboxylate (3), 1,3-bis(2,6-diisopropylphenyl)tetrahydropyrimidinium-2-carboxylate (4), 1,3-biscyclohexyltetrahydropyrimidinium-2-carboxylate (12), 1,3-bis(4-heptyl)tetrahydropyrimidinium-2-carboxylate (12) and 1,3-bis(2,4-dimethoxyphenyl)tetrahydropyrimidinium-2-carboxylate (15):

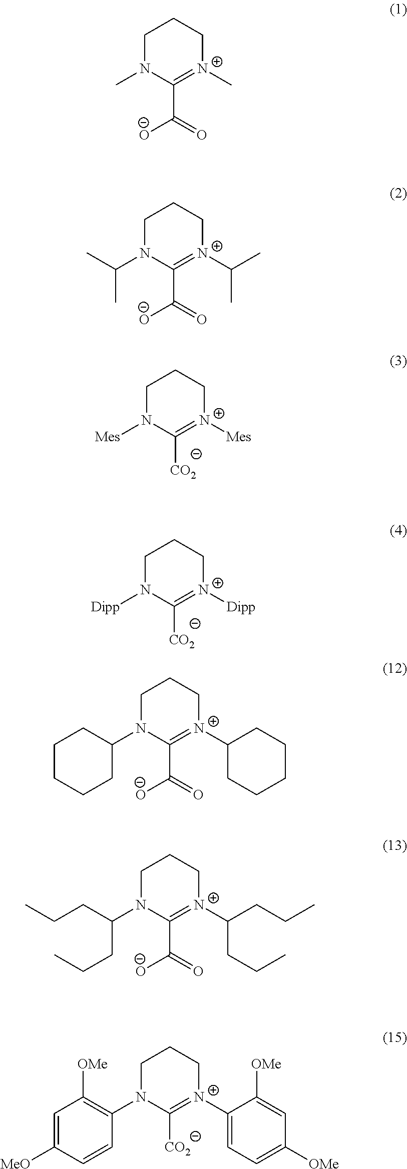

Here, Mes represents a 2,4,6-trimethylphenyl group and Dipp represents a 2,6-diisopropylphenyl group.

Examples of formula (I) having a seven-membered ring, i.e. R₁ is a (CH₂)₃ group, are 1,3-bis(2,4,6-trimethylphenyl)tetrahydro-[1,3]-diazepinium-2-carboxylate (10) and 1,3-bis(2,6-diisopropylphenyl)tetrahydro-[1,3]-diazepinium-2-carboxylate (11):

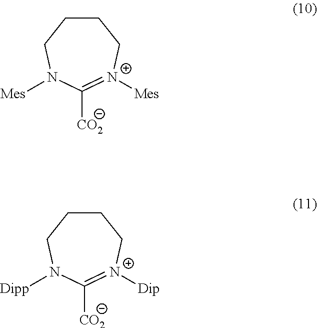

Examples of compounds of formula (II) are 1,3-diisopropylimidazolium-2-carboxylate (5), 1,3-ditertbutylimidazolium-2-carboxylate (6), 1,3-dicyclohexylimidazolium-2-carboxylate (7), 1,3-bis(2,4,6-trimethylphenyl)imidazolium-2-carboxylate (8) and 1,3-adamantylimidazolium-2-carboxylate (9):

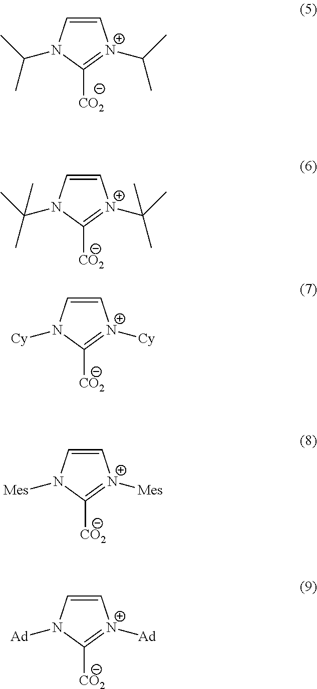

Here, Cy represents a cyclohexyl group and Ad represents an adamantly group.

Examples of initiators of formula (I) with R₁ equal to CH₂ are 1,3-ditertbutylimidazolinium-2-carboxylate (14) and 1,3-di(2,4,6-trimethylphenyl)imidazolinium-2-carboxylate (14a):

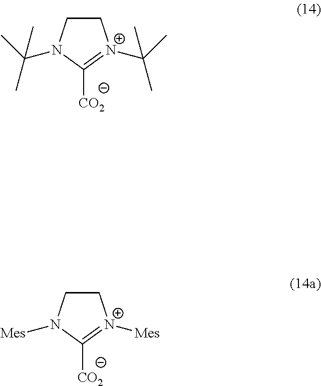

Examples of metal-protected N-heterocyclic carbenes are the compounds (16) to (19):

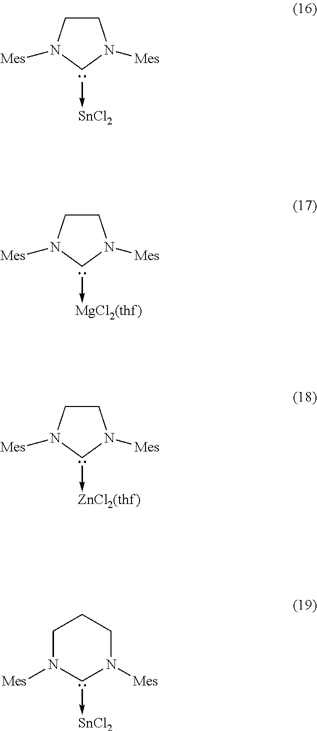

Metal-protected N-heterocyclic carbenes may also be present in the form of a dimer. An example of this is compound (20):

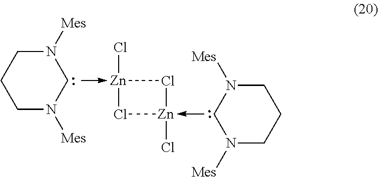

The preparation of these compounds is generally known from the literature. In particular, the cyclization of amidines, which are readily available from amines and orthoesters, offers a simple approach to various ring sizes.

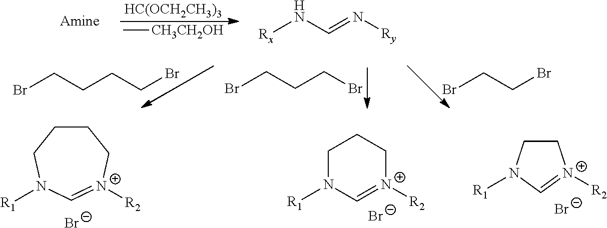

The deprotonation in this instance is preferably carried out using a strong, sterically hindered base such as potassium hexamethyldisilazane (KHMDS) in a solvent such as THF. The solvent is removed and the residue is slurried with, for example, Et₂O. After filtration, CO₂ or another protective group such as SnCl₂ is added. A further subsequent filtration in diethyl ether for example, and drying under reduced pressure allows the synthesis of clean target compounds such that an additional recrystallization is often unnecessary. In conjunction with the simple formation of amidines and their cyclization with dihalides, this is an attractive synthetic route with a minimal number of stages in which no chromatography or other purifications are necessary. These two reactions may also be carried out, for example, in an air atmosphere. Only the formation of the free carbene by reaction with the strong base has to be conducted under the exclusion of air. The synthesis may be consulted, for example, in Iglesias et al., Organometallics 2008, 27, 3279-3289. The synthesis of corresponding CS₂ complexes may be consulted, for example, in Delaude, Eur. J. Inorg. Chem. 2009, 1681-1699 or in Delaude et al., Eur. J. Inorg. Chem. 2009, 1882-1891.

It has been found that, surprisingly, the polymerization can be carried out very rapidly at comparatively low temperatures of, for example, 80° C. depending on the protected N-heterocyclic carbene selected. For instance, a 50% conversion of the monomers is possible at 80° C. even at t₅₀<50 min. At the same time, the polymerization solutions or else a pure monomer mixture, containing the N-heterocyclic carbene, may be combined such that these do not lead to a polymerization at room temperature for several hours. A major advantage of the present invention is, therefore, the latency of the polymerization.

This combination yields major advantages in industrial methods. Thus, reaction mixtures may be prepared and be initiated at any time point in a controlled manner by means of a simple temperature increase. The mixtures can thus be mixed, for example, outside a reaction vessel and be transferred to a reaction tank only for the pure polymerization. Moreover, on the basis of such an initiator system, a continuous polymerization can be carried out with continuous addition of the reaction mixture in a tubular reactor or loop reactor or an extruder or kneader.

In addition, the polymerization can be optimized such that a virtually quantitative conversion of the monomers takes place. This is possible both in solution polymerization and in a bulk polymerization.

Moreover, the molecular weights of the polymers may be adjusted in a wide spectrum with the method according to the invention. In particular, polymers may be prepared with a weight average molecular weight between 5000 and 50 000 g/mol determined by a GPC measurement against a polystyrene standard.

Furthermore, novel protected N-heterocyclic carbenes are also part of the present invention. For instance, the above-mentioned compounds (17), (18) and (20) are novel compounds. In particular, the compounds (17) and (18) are particularly active initiators for the polymerization of lactones. The novel compounds (17) and (18) are not limited to compounds having a solvent molecule, such as THF, coordinated to the metal. Therefore, the compounds (17′) and (18′) in particular are also part of the present invention:

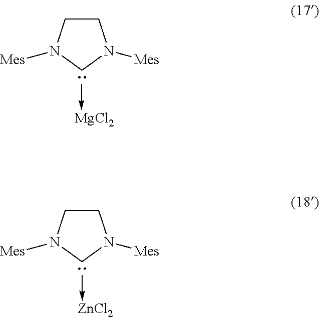

### EXAMPLES

### General Polymerization Procedure

For the polymerization, the monomers, the initiator, optionally benzyl alcohol and optionally a solvent, e.g. DMSO, DMF or toluene, were together weighed out in a glove box under an argon atmosphere and, in the case of a bulk polymerization, transferred to a glass pressure vessel. In the case of a solution polymerization, dry DMSO was used as solvent and a Schlenk flask was used as reaction vessel. The exact amounts and the type of initiators used and optionally further components can be found in Tables 1 and 2.

The glass pressure vessel or the Schlenk flask was heated in an oil bath preheated to the desired temperature for the period of the polymerization. In the case of a bulk polymerization, the polymer materials formed were subsequently dissolved in chloroform. Precipitation was effected by dripping this solution or the product of a solution polymerization into pentane. After centrifugation, the supernatant solution was removed and the polymer was dried under reduced pressure. The stated yields are the isolated amounts of polymer following drying.

Table 1 shows initial results of a bulk polymerization of ε-caprolactone (monomer).

TABLE 1

| | | | | Molar ratio | | | |
|---|---|---|---|---|---|---|---|
| | | Temperature | Time | NHC/Benzyl alcohol/ | Yield | Mₙ (PDI) | |
| Example | NHC | [° C.] | [h] | Monomer | [%] | [g/mol] | |
| 1 | (5) | 70 | 22 | 1:2:280 | 97 | 15 000 | (1.70) |
| 2 | (5) | 90 | 8 | 1:2:280 | 91 | 17 000 | (1.72) |
| 3 | (7) | 70 | 22 | 1:2:280 | 63 | 11 000 | (1.40) |
| 4 | (6) | 70 | 22 | 1:2:280 | 41 | 4000 | (1.35) |
| 5 | (14) | 70 | 22 | 1:2:280 | 27 | 2700 | (1.20) |
| 6 | (9) | 70 | 22 | 1:2:280 | 26 | 4500 | (1.41) |
| 7 | (12) | 70 | 22 | 1:2:280 | 56 | 8000 | (1.44) |
| 8 | (12) | 70 | 22 | 1:5:280 | 86 | 5000 | (1.23 |
| 9 | (2) | 70 | 22 | 1:2:280 | 17 | n.d. | |
| 10 | (13) | 70 | 22 | 1:2:280 | 23 | 2600 | (1.20) |
| 11 | (16) | 70 | 5 | 1:5:280 | 83 | 6000 | (1.67) |
| 12 | (16) | 70 | 5 | 1:2:280 | 71 | 16 500 | (1.69) |
| 13 | (18) | 70 | 5 | 1:2:280 | 88 | 12 000 | (1.68) |
| 14 | (18) | 130 | 0.25 | 1:2:280 | 100 | 16 000 | (1.68) |
| 15 | (17) | 70 | 5 | 1:2:280 | 86 | 9 000 | (1.73) |
| 16 | (17) | 90 | 0.25 | 1:2:280 | 96 | 13 500 | (1.93) |
| 17 | (20) | 130 | 0.25 | 1:2:280 | 100 | 16 500 | (1.64) |
| 18 | (20) | 70 | 5 | 1:2:280 | 9 | n.d. | |
| 19 | (19) | 70 | 5 | 1:2:280 | 82 | 13 500 | (1.71) |

It is evident from the examples that the conversion, the starting temperature and the molecular weight may be adjusted by selecting the initiators and the polymerization temperature. In addition, it is evident that a broad molecular weight spectrum, sometimes with very narrow molecular weight distributions (PDI), is achievable. Furthermore, it is evident that even quantitative conversions can be achieved within very short polymerization times.

Comparative examples (CE) are shown in Table 2. CE1 and CE2 show that the same system without addition of the inventive initiator shows no polymerization activity. CE3 to CE5 show that no polymerization, or no notable polymerization, occurs at room temperature in accordance with the invention. The systems are therefore latent.

It may be noted that the yields below 10% in CE3 to CE6 and also in inventive example 18 were determined by ¹H-NMR.

TABLE 2
Comparative examples

| | | | | Molar ratio | | |
|---|---|---|---|---|---|---|
| | | Temperature | Time | NHC/Benzyl alcohol/ | Yield | Mₙ (PDI) |
| Example | NHC | [° C.] | [h] | Monomer | [%] | [g/mol] |
| CE1 | — | 70 | 18 | 0:5:280 | 0 | — |
| CE2 | — | 130 | 0.25 | 0:2:280 | 0 | — |
| CE3 | (5) | RT | 22 | 1:2:280 | 3 | — |
| CE4 | (7) | RT | 22 | 1:2:280 | 1 | — |
| CE5 | (12) | RT | 22 | 1:2:280 | 1 | — |
| CE6 | (16) | RT | 19 | 1:5:280 | 3 | — |
| CE7 | (18) | RT | 19 | 1:2:280 | 0 | — |

1: A method for initiating a polymerization of lactones, the method comprising:
treating a monomer mixture or a monomer solution of the lactones with a protected N-heterocyclic carbine, and
initiating the polymerization by increasing temperature to a starting temperature of at least 40° C.

2: The method of claim 1, wherein the lactone is γ-butyrolactone, δ-valerolactone or ε-caprolactone.

3: The method of claim 1, wherein the protected N-heterocyclic carbene is a compound of formula (I) or formula (II) 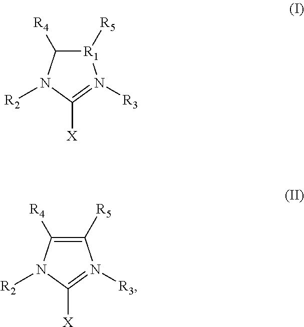
where
R₁ is a CH₂, C₂H₄, C₃H₆ or a corresponding substituted residue,
R₂ and R₃ are each independently a cyclic, branched or linear, optionally heteroatom-comprising alkyl residue comprising from 1 to 20 carbon atoms or are a substituted or unsubstituted aromatic residue,
R₄ and R₅ are each independently hydrogen, a cyclic, branched or linear, optionally heteroatom-comprising alkyl residue comprising from 1 to 20 carbon atoms or are a substituted or unsubstituted aromatic residue, and
X is CO₂, CS₂, ZnX′₂, BiX′₃, SnX′₂ or MgX′₂, where X′ is a halogen or a pseudohalogen.

4: The method of claim 1, wherein the protected N-heterocyclic carbene is a compound of formula (III) or formula (IV) 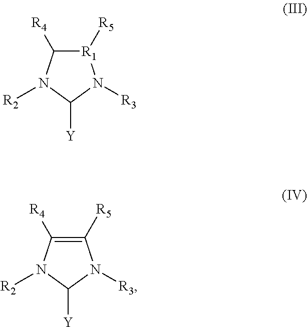
where
R₁ is a CH₂, C₂H₄, C₃H₆ or a corresponding substituted residue,
R₂ and R₃ are each independently a cyclic, branched or linear, optionally heteroatom-comprising alkyl residue comprising 1 to 20 carbon atoms or are a substituted or unsubstituted aromatic residue,
R₄ and R₅ are each independently hydrogen, a cyclic, branched or linear, optionally heteroatom-comprising alkyl residue comprising from 1 to 20 carbon atoms or are a substituted or unsubstituted aromatic residue, and
Y is a CF₃, C₆F₄, C₆F₅, CCl₃, OR₆ residue, where R₆ is an alkyl residue comprising from 1 to 10 carbon atoms, ZnX′₂, BiX′₃, SnX′₂ or MgX′₂, where X′ is a halogen or a pseudohalogen.

5: The method of claim 1, wherein the monomer mixture or the monomer solution is treated with an alcohol prior to the polymerization.

6: The method of claim 5, wherein the alcohol is a phenol or a benzyl alcohol, and that this the alcohol is added to the N-heterocyclic carbene in a ratio of the alcohol to the N-heterocyclic carbine of from 0:1 to 10.

7: The method of claim 1, wherein a polymer obtained from the polymerization has a weight average molecular weight between 5000 and 50 000 g/mol in a GPC measurement against a polystyrene standard.

8: The method of claim 1, wherein the starting temperature is between 50° C. and 100° C.

9: The method of claim 1, wherein a fibrous support material is saturated with a composition comprising the lactones and the protected N-heterocyclic carbene prior to the polymerization and the temperature is subsequently increased to the starting temperature.

10: A protected N-heterocyclic carbene, wherein the N-heterocyclic carbene is 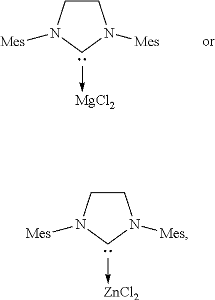
where an additional ligand is optionally coordinated to the metal.
